(19) United States
(12) Patent Application Publication
(10) Pub. No.: US 2004/0016514 A1
(43) Pub. Date: Jan. 29, 2004

(54) Combination blind with multiple shading sections

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314

(73) Assignee: NIEN MADE ENTERPRISE CO., LTD., Taichung (TW)

(21) Appl. No.: 10/281,210

(22) Filed: Oct. 28, 2002

(30) Foreign Application Priority Data
Jul. 23, 2002 (TW) 91211413

(51) Int. Cl. E06B 3/48

(52) U.S. Cl. 160/115

(57) ABSTRACT

A combination blind is constructed to include a headrail and a bottom rail respectively connectable to the top and bottom sides of a window, and a lifting rail arranged in parallel to and vertically movable between the headrail and the bottom rail. The lifting rail defines with the headrail and the bottom rail two vertically spaced shading sections. Two positioning cords are bilaterally vertically connected between the headrail and the bottom rail and extended through the two shading sections and inserted through the lifting rail. The positioning cords each have a part transversely extended through the lifting rail at a distance. Two blind bodies are respectively provided in the two shading sections and relatively extended out/received upon vertical movement of the lifting rail between the headrail and the bottom rail.

### BACKGROUND OF THE INVENTION

1. Field of the Invention

The present invention relates to blinds and, more specifically, to a combination blind, which comprises two blind bodies respectively provided in two vertically spaced shading sections that can be relatively adjusted so as to provide multiple shading sections.

2. Description of the Related Art

Regular vertically adjustable blinds are numerous, including Venetian blinds, Roller blinds, Pleated blinds, Honeycomb shades, Roman blinds, and etc. These blinds provide different shading effects and different styles. Generally, a vertically adjustable blind comprises a headrail, a bottom rail suspended below the headrail, and slats or shade body connected between the headrail and the bottom rail. Except the advanced motor-driven designs, a vertically adjustable blind further comprises a lift cord suspended from the headrail at one side for operation by hand to control the elevation of the bottom rail. These conventional blinds have following two common drawbacks:

1. Although different styles of blinds provide different shading characteristics and functions (for example, a silk roller blind softens the light; a Venetian blind can regulate the light), however one blind has only one fixed blind body design functioning for a particular purpose. For example, a Venetian blind can be adjusted to change its shading area and to regulate the light. However, the user cannot open the upper (or lower) part of the blind body of a Venetian blind, leaving the lower (or upper) part of the blind body closed.

2. Because the lift cord of a conventional blind is exposed to the outside, it destroys the sense of beauty of the blind. Further, because a child can easily reach the exposed lift cord, an accident may occur when a child pulling the lift cord for fun.

### SUMMARY OF THE INVENTION

The present invention has been accomplished under the circumstances in view. It is the main object of the present invention to provide a combination blind, which eliminates the aforesaid drawbacks.

It is another object of the present invention to provide a combination blind, which combines multiple blind bodies into a blind assembly, so that the blind assembly provides versatile shading functions.

It is still another object of the present invention to provide a combination blind, which keeps the cord members out of reach of children.

To achieve these objects of the present invention, the combination blind comprises a headrail and a bottom rail respectively connectable to the top and bottom sides of a window, and at least one lifting rail arranged in parallel to and vertically movable between the headrail and the bottom rail. The at least one lifting rail defines with said headrail and said bottom rail at least two vertically spaced shading sections. Two positioning cords are bilaterally vertically connected between the headrail and the bottom rail and extended through the at least two shading sections and inserted through the at least one lifting rail. The positioning cords each have a part transversely extended through each of the at least one lifting rail at a distance. At least two blind bodies are respectively provided in the at least two shading sections and relatively extended out/received upon vertical movement of said at least one lifting rail between said headrail and said bottom rail.

### BRIEF DESCRIPTION OF THE DRAWINGS

FIG. 1 is a schematic drawing of the first preferred embodiment of the present invention, showing the lifting rail held at about the mid point between the headrail and the bottom rail.

FIG. 2 is an operational view of the first preferred embodiment of the present invention, showing the lifting rail held at a relatively higher elevation.

FIG. 3 is another operational view of the first preferred embodiment of the present invention, showing the lifting rail held at a relatively lower elevation.

FIG. 4 is a schematic structural view of the second preferred embodiment of the present invention.

FIG. 5 is a schematic structural view of the third preferred embodiment of the present invention

FIG. 6 is a schematic structural view of the fourth preferred embodiment of the present invention.

FIG. 7 is a schematic structural view of the fifth preferred embodiment of the present invention.

FIG. 8 is a sectional view taken along line 8-8 of FIG. 7.

FIG. 9 is a schematic structural view of the sixth preferred embodiment of the present invention.

### DETAILED DESCRIPTION OF THE PREFERRED EMBODIMENT

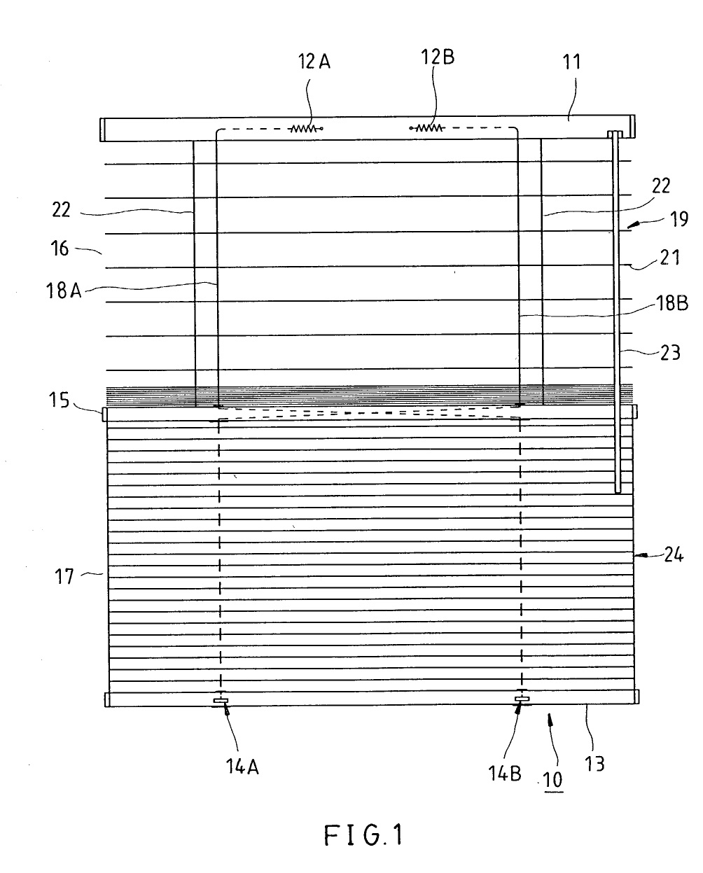

Referring to FIG. 1, a combination blind 10 is shown comprising a headrail 11, a bottom rail 13, a lifting rail 15, two positioning cords 18A and 18B, an upper blind body 19, and a lower blind body 24.

The headrail 11 is fixedly transversely (horizontally) fastened to the top side of the window, having a first tensile spring 12A and a second tensile spring 12B bilaterally provided on the inside and horizontally aligned in line. The tensile springs 12A and 12B each have an inner end respectively fixedly fastened to a part inside the headrail 11. The other end of each of the tensile springs 12A and 12B is defined as a connecting end.

The bottom rail 13 is fixedly transversely (horizontally) fastened to the bottom side of the window. For example, two brackets may be used to fixedly fasten to the left and right ends of the bottom rail 13 to the bottom side of the window. Two tension control members 14A and 14B are bilaterally located on the bottom rail 13. Because the tension control members 14A and 14B are not within the scope of the claims of the present invention, no further detailed description in this regard is necessary. It is, however, to be noted that these tension control members have been disclosed in Taiwanese patent application No.91204732.

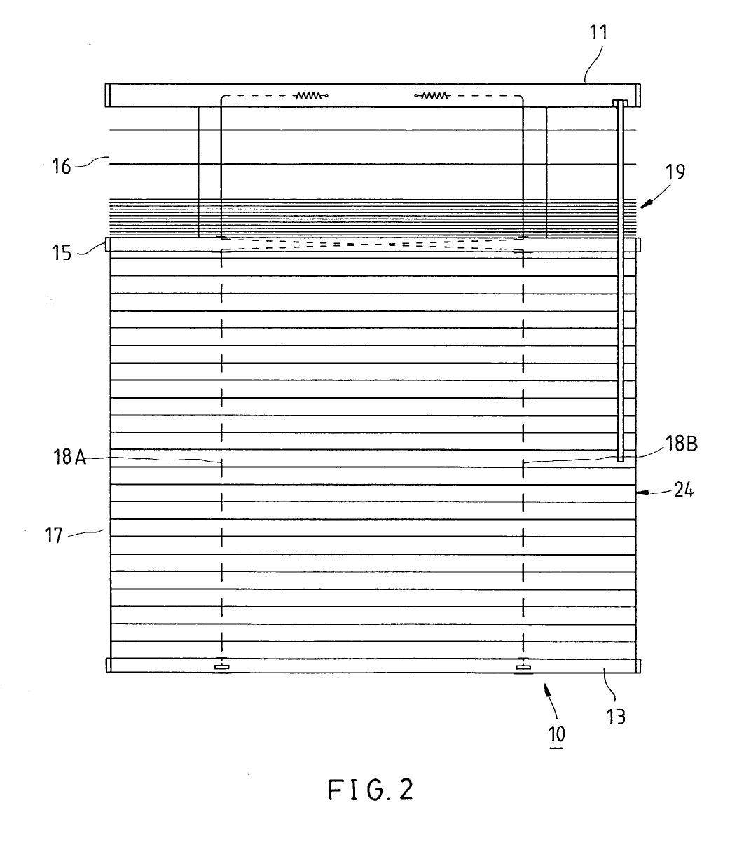

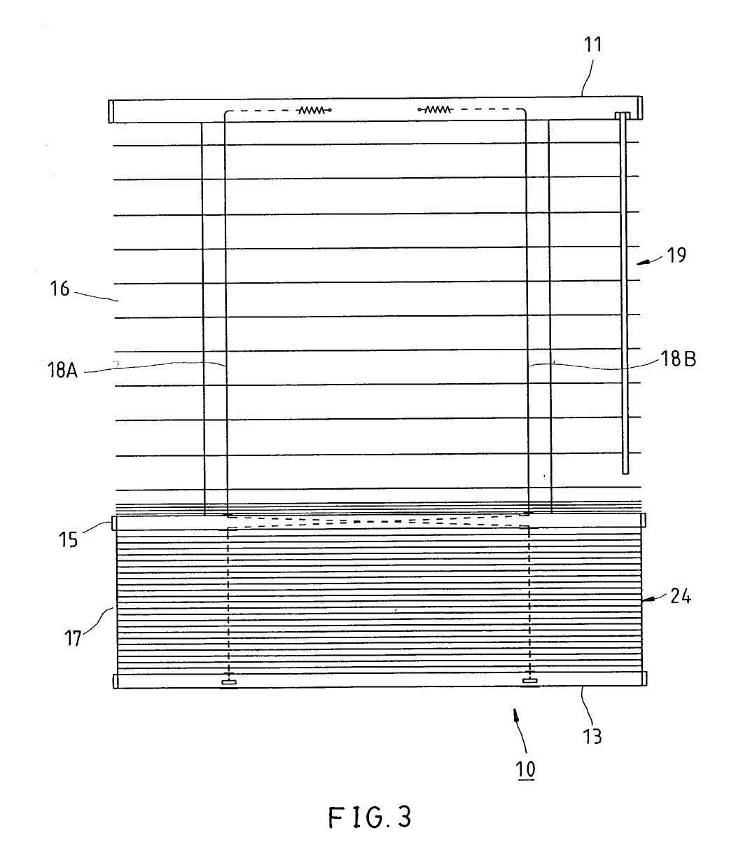

The lifting rail 15 is a hollow transverse rod member arranged in parallel between the headrail 11 and the bottom rail 13 and vertically movably between the headrail 11 and the bottom rail 13 (this will be described further). The lifting rail 15 separates the space between the headrail 11 and the bottom rail 13 two vertically spaced shading sections 16 and 17, i.e., the upper shading section 16 between the headrail 11 and the lifting rail 15 and the lower shading section 17 between the lifting rail 15 and the bottom rail 13. Because the lifting rail 15 is vertically movable between the headrail 11 and the bottom rail 13, the shading sections 16 and 17 are relatively changed subject to vertical movement of the lifting rail 15 between the headrail 11 and the bottom rail 13 (see FIGS. 2 and 3).

The positioning cords 18A and 18B are bilaterally symmetrically arranged in parallel between the headrail 11 and the bottom rail 13. According to this embodiment, the positioning cords 18A and 18B each have a top end respectively connected to the connecting ends of the tensile springs 12A and 12B in the headrail 11 and a bottom end respectively connected to the tension control members 14A and 14B at the bottom rail 13. The tension control members 14A and 14B can be controlled to roll up the positioning cords 18A and 18B, so as to relatively adjust the tension of the positioning cords 18A and 18B. As indicated in FIG. 1, one positioning cord, namely, the first positioning cord 18A is extended horizontally leftwards in the headrail 11 from the connecting end of the first tensile spring 12A and then vertically turned downwards to the outside of the headrail 11, and then vertically downwardly extended through the upper shading section 16 into the inside of the lifting rail 15, and then extended horizontally rightwards in the lifting rail 15 toward the right end of the lifting rail 15, and then vertically downwardly extended out of the lifting rail 15 toward the bottom rail 13 through the lower shading section 17, and then connected to the second tension control member 14B. The other positioning cord, namely, the second positioning cord 18B is extended horizontally rightwards in the headrail 11 from the connecting end of the second tensile spring 12B and then vertically turned downwards to the outside of the headrail 11, and then vertically downwardly extended through the upper shading section 16 into the inside of the lifting rail 15, and then extended horizontally leftwards in the lifting rail 15 toward the left end of the lifting rail 15, and then vertically downwardly extended out of the lifting rail 15 toward the bottom rail 13 through the lower shading section 17, and then connected to the first tension control member 14A.

The upper blind body 19 is provided in the upper shading section 16 between the headrail 11 and the lifting rail 15. According to this embodiment, the upper blind body 19 is constructed subject to the design of a Venetian blind, comprised of a set of slats 21 arranged in parallel between the headrail 11 and the lifting rail 15, two vertical ladder cords 22 joining the slats 21. The upper blind body 19 further comprises a tilting control mechanism adapted for controlling the tilting angle of the slats 21. Because the tilting control mechanism is of the known art and not within the scope of the claims of the present invention, no further detailed description in this regard is necessary. In FIG. 1, only the tilt rod 23 of the tilting control mechanism is shown. The aforesaid positioning cords 18A and 18B are respectively inserted through a respective through hole (not shown) in each slat 21 but not fixedly connected to the slats 21, i.e., the positioning cords 18A and 18B are suspended in the upper shading section 16 within the left and right sides of the upper blind body 19.

The lower blind body 24 is provided in the lower shading section 17 between the lifting rail 15 and the bottom rail 13. According to this embodiment, the lower blind body 24 is constructed subject to the design of a pleated blind. The top and bottom sides of the lower blind body 24 are respectively fastened to the bottom sidewall of the lifting rail 15 and the top sidewall of the bottom rail 13. The positioning cords 18A and 18B are suspended in the lower shading section 17 within the left and right sides of the lower blind body 24 and directly extended through the lower blind body 24.

The aforesaid statement describes the structure of the combination blind according to the first embodiment of the present invention. Normally, the tension force of the positioning cords 18A and 18B supports the lifting rail 15 at an elevation, and at the same time the user can hold the lifting rail 15 in horizontal and move it upwards or downwards. When the user released the hand from the lifting rail 15, the lifting rail 15 is held at the adjusted elevation.

By means of the aforesaid arrangement, the combination blind 10 provides a Venetian blind in the upper shading section 16 and a pleated blind in the lower shading section 17. Further, when the lifting rail 15 lifted, the upper blind body 19 is received upwards in the upper shading section 16, and the lower blind body 24 is extended upwards in the lower shading section 17 as shown in FIG. 2. On the contrary, when lowered the lifting rail 15, the upper blind body 19 is downwardly extended out, and at the same time the lower blind body 24 is relatively received, as shown in FIG. 3. In short, the user can adjust the elevation of the lifting rail 15 to change the area ratio between the upper blind body 19 and the lower blind body 24 (when the lifting rail 15 lowered to the lower limit position, the combination blind 10 is shown as a Venetian blind). As indicated above, the combination blind 10 is indeed a versatile design for a variable application.

Further, because the combination blind 10 keeps the cords 18A and 18B out of reach of children, it is safety in use.

According to the aforesaid embodiment, the first ends (the top ends) of the positioning cords 18A and 18B are respectively connected to the connecting ends of the tensile springs 12A and 12B in the headrail 11, so that the positioning cords 18A and 18B have a sufficient tension force to support the lifting rail 15 at a particular elevation and to let the lifting rail 15 be movable between the headrail 11 and the bottom rail 13 by the user. Alternatively, the tensile springs 12A and 12B can be respectively installed in the two ends of the headrail 11. In this case, the outer end of each tensile spring 12A or 12B is fixedly fastened to the headrail 11, and the inner end of each tensile spring 12A and 12B is connected to the corresponding positioning cord 18A or 18B. It is also applicable to fixedly secure the first ends (top ends) of the positioning cords 18A and 18B to the headrail 11, and to connect the second ends (bottom ends) of the positioning cords 18A and 18B to a respective tensile spring in the bottom rail 13. The positioning cords 18A and 18B can be obtained from elastic cord members without the tensile springs. The tensile springs can be eliminated even if the positioning cords have no elasticity. Further, the aforesaid tension control members 14A and 14B are not requisite members of the combination blind 10.

In the aforesaid first embodiment of the present invention, the upper blind body 19 is constructed subject to the design of a Venetian blind, and the lower blind body 24 is constructed subject to the design of a pleated blind. In actual practice, the upper blind body and the lower blind body can be respectively constructed subject to the design of any of a variety of blinds including Venetian blinds, Roller blinds, Pleated blinds, Honeycomb shades, Roman blinds, and etc.

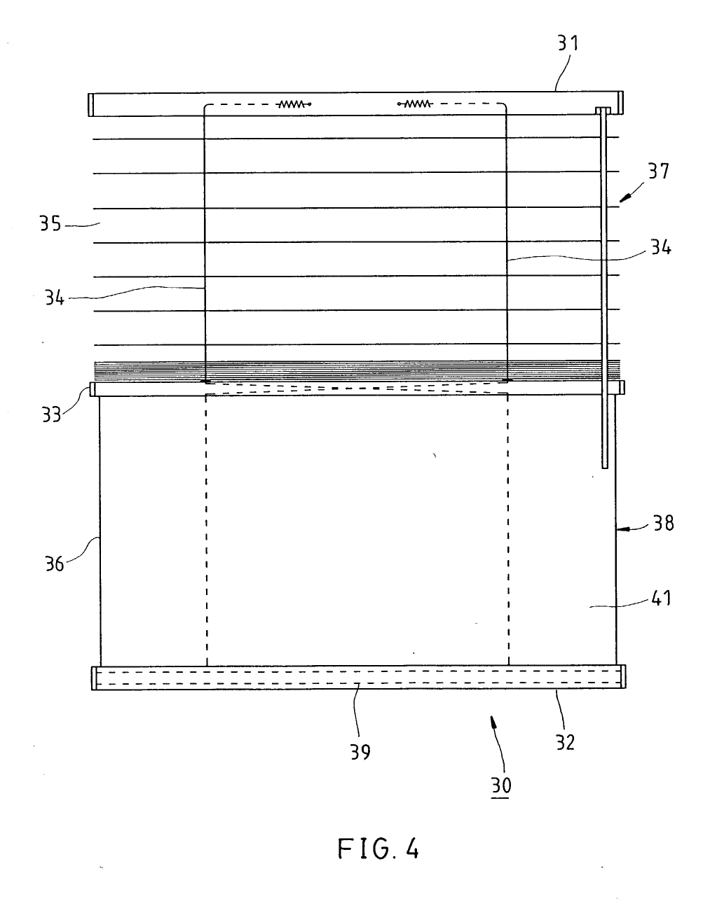

FIG. 4 shows a combination blind 30 constructed according to the second preferred embodiment of the present invention. According to this embodiment, the combination blind 30 is comprised of a headrail 31, a bottom rail 32, a lifting rail 33 movable between the headrail 31 and the bottom rail 32, two positioning cords 34 adapted to hold the lifting rail 33 at the desired elevation between the headrail 31 and the bottom rail 32, an upper blind body 37 provided in the upper shading section 35 between the headrail 31 and the lifting rail 33, and a lower blind body 38 provided in the lower shading section 36 between the lifting rail 33 and the bottom rail 32. The major parts of this second embodiment are same as the equivalent parts of the aforesaid first embodiment. However, the lower blind body 38 is constructed subject to the design of a roller blind, i.e., the lower blind body 38 comprises a barrel 39 axially provided within the bottom rail 32, a reversible winding mechanism (not shown) provided inside the barrel 39, and a shade body 41. The shade body 41 has a top side fixedly connected to the bottom sidewall of the lifting rail 33, and a bottom side inserted through a longitudinal slot (not shown) in the periphery of the barrel 39 and connected to the reversible winding mechanism. When the lifting rail 33 lowered, the reversible winding mechanism automatically winds up the shade body 41. The winding force of the reversible winding mechanism does not surpass the tension force of the positioning cords 34, so that the positioning cords 34 can hold the lifting rail 33 positively at the desired elevation. Alternatively, the barrel 39 and reversible winding mechanism of the lower blind body 38 can be installed in the lifting rail 33.

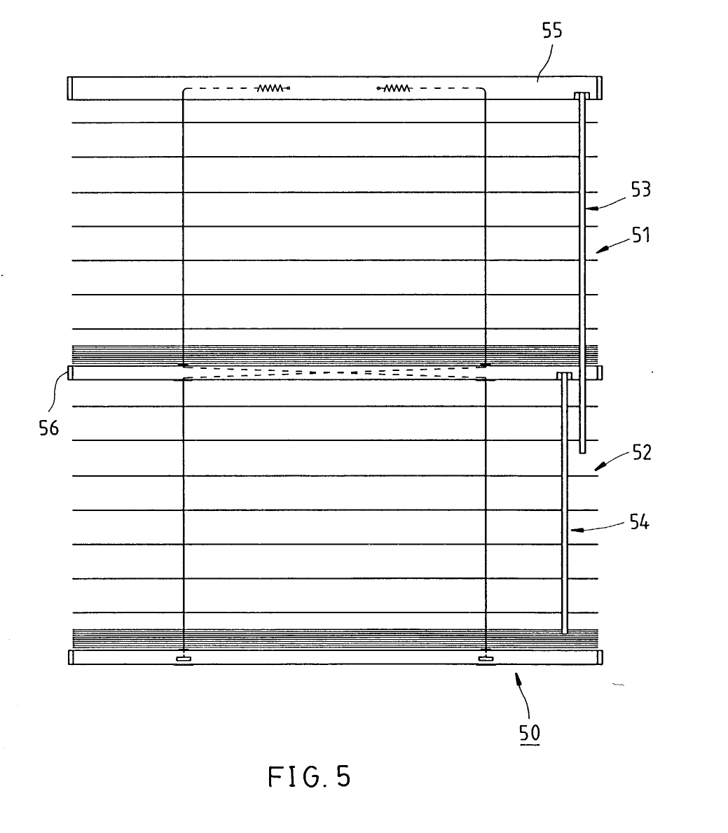

FIG. 5 shows a combination blind 50 constructed according to the third preferred embodiment of the present invention. According to this embodiment, the upper blind body 51 and the lower blind body 52 are respectively constructed subject to the design of a Venetian blind, each having a respective tilt rod 53 or 54 (the tilt rod 53 is provided at the headrail 55; the tilt rod 54 is provided at the lifting rail 56). The user can operate the tilt rod 53 or 54 to regulate the tilting angles of the slats of the upper blind body 51 or lower blind body 52 respectively. Further, the upper blind body and the lower blind body can be of the same design (Roller blind or Pleated blind) but made of different materials having different permeability for light.

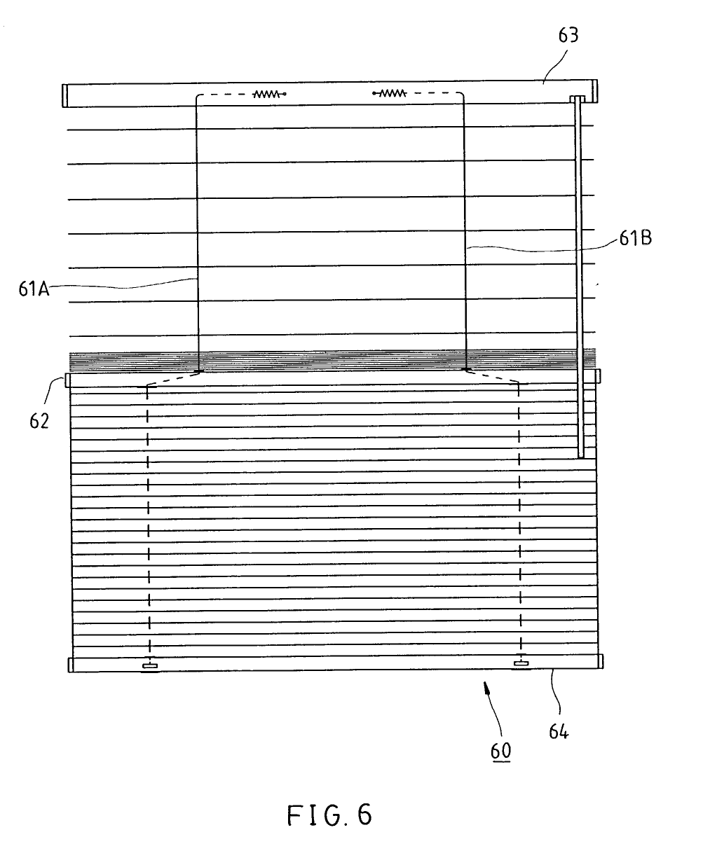

FIG. 6 shows a combination blind 60 constructed according to the fourth preferred embodiment of the present invention. According to this embodiment, the positioning cords 61A and 61B are not extended across each other, i.e., the first positioning cord 61A has a top end connected to the headrail 63, and a bottom end obliquely inserted through the lifting rail 62 in direction toward the left end of the lifting rail 62 and then turned vertically downwards to the bottom rail 64; the second positioning cord 61B has a top end connected to the headrail 63, and a bottom end obliquely inserted through the lifting rail 62 in direction toward the right end of the lifting rail 62 and then turned vertically downwards to the bottom rail 64. This positioning cord positioning arrangement also enables the positioning cords 61A and 61B to hold the lifting rail 62 at the desired elevation.

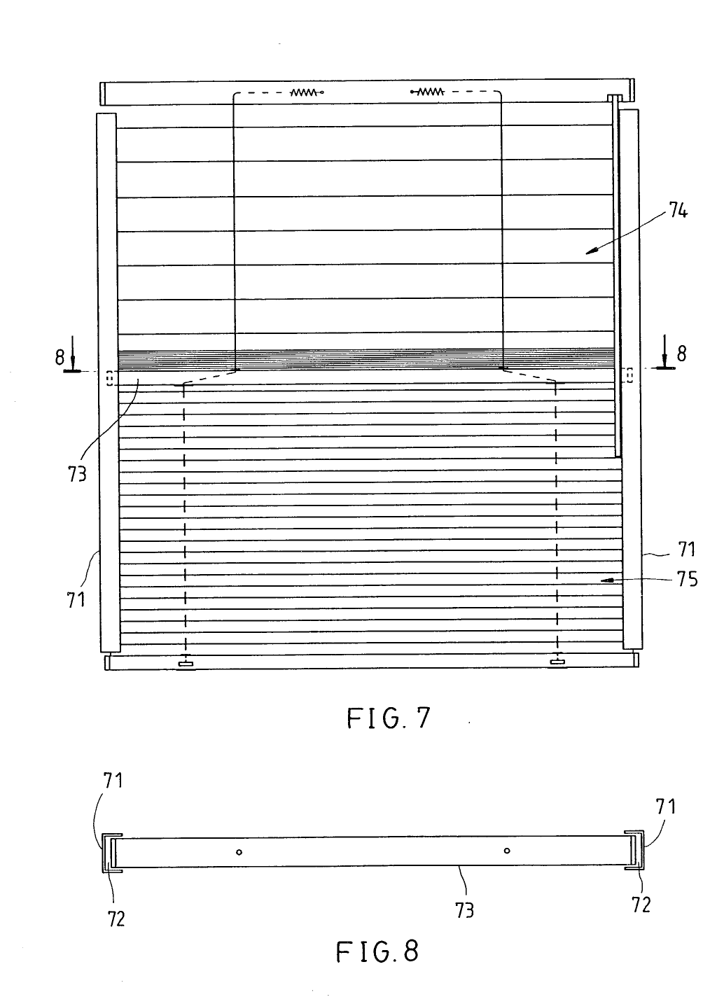

FIGS. 7 and 8 show a combination blind constructed according to the fifth preferred embodiment of the present invention. According to this embodiment, two vertical guide rails 71 are fixedly provided at two sides of the window, each having a longitudinal guide groove 72, which receives one end of the lifting rail 73 to guide vertical movement of the lifting rail 73 along the vertical guide rails 71. By means of the guidance of the guide rails 71, the combination blind is prohibited from flying in the wind.

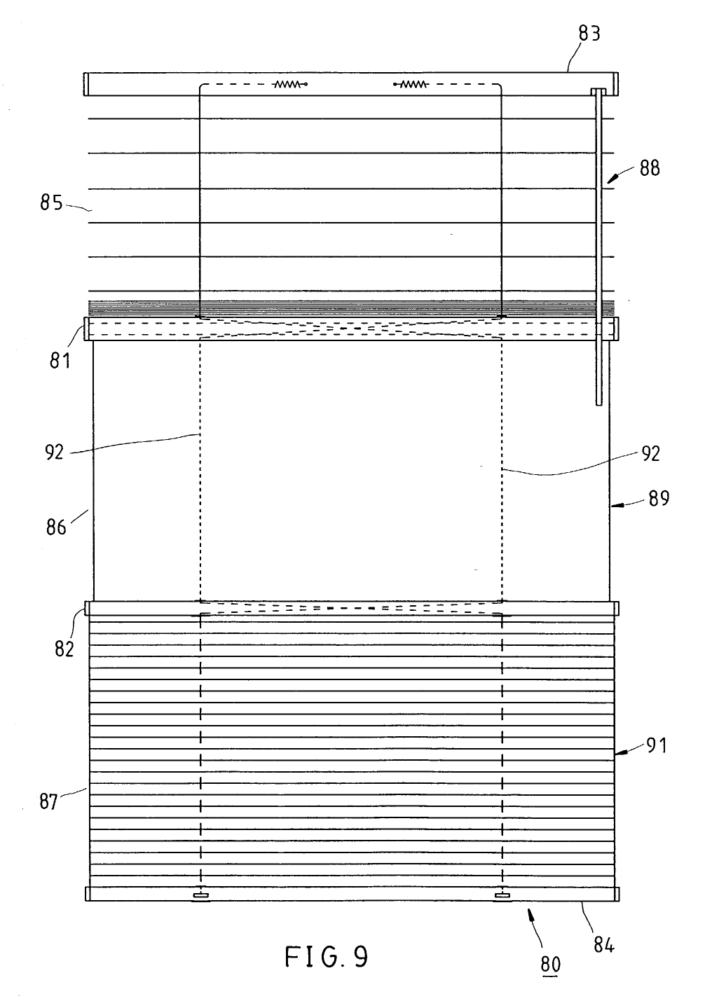

FIG. 9 shows a combination blind constructed 80 according to the sixth preferred embodiment of the present invention. According to this embodiment, two lifting rails 81 and 82 are arranged in parallel between the headrail 83 and the bottom rail 84, defining an upper shading section 85, an intermediate shading section 86, and a lower shading section 87. Three blind bodies, namely, the upper blind body 88, the intermediate blind body 89, and the lower blind body 91 are respectively provided in the shading sections 85, 86, and 87. The arrangement of the positioning cords, referenced by 92, is similar to the aforesaid first embodiment of the present invention, i.e., the positioning cords 92 are connected between the headrail 83 and the bottom rail 84, and extended across each other in each of the lifting rails 81 and 82.

What the invention claimed is:

1. A combination blind installed in a window for regulating the light, comprising:
a headrail connectable to a top side of said window;
a bottom rail connectable to a bottom side of said window;
at least one lifting rail arranged in parallel to and vertically movable between said headrail and said bottom rail, said at least one lifting rail defining with said headrail and said bottom rail at least two vertically spaced shading sections;
two positioning cords bilaterally vertically connected between said headrail and said bottom rail and extended through said at least two vertically spaced shading sections and inserted through said at least one lifting rail, said positioning cords each having a part transversely extended through each of said at least one lifting rail at a distance; and
at least two blind bodies respectively provided in said at least two shading sections and relatively extended out/received upon vertical movement of said at least one lifting rail between said headrail and said bottom rail.

2. The combination blind as claimed in claim 1, wherein the number of said at least one lifting rail is one, and the single lifting rail defines with said headrail and said bottom rail two vertically spaced shading sections.

3. The combination blind as claimed in claim 1, wherein the number of said at least one lifting rail is two, and the two lifting rails define with said headrail and said bottom rail three vertically spaced shading sections.

4. The combination blind as claimed in claim 1, wherein said headrail has two tensile springs provided therein, said tensile springs each having a fixed end fixedly connected to said headrail and a connecting end; wherein said two positioning cords each have a top end respectively connected to the connecting ends of said tensile springs in said headrail.

5. The combination blind as claimed in claim 1, wherein said bottom rail comprises two tension control members respectively connected to bottom ends of said positioning cords, and adapted for rolling up said positioning cords to relatively adjust the tension of said positioning cords.

6. The combination blind as claimed in claim 1, wherein said two positioning cords are extended across each other in each of said at least one lifting rail.

7. The combination blind as claimed in claim 1, wherein said at least two blind bodies are respectively constructed subject to one of the blind groups of Venetian blind, Roller blind, Pleated blind, and Roman blind.

8. The combination blind as claimed in claim 1, wherein said at least two blind bodies are constructed subject to two designs of blinds.

9. The combination blind as claimed in claim 1, wherein said at least two blind bodies are constructed subject to a same design of blind.

10. The combination blind as claimed in claim 9, wherein said at least two blind bodies are constructed subject to the design of a Venetian blind, each having a respective slat tilting control mechanism.

11. The combination blind as claimed in claim 1, further comprising two vertical guide rails vertically arranged in parallel and connectable to two opposite lateral sides of said window for guiding vertical movement of said at least one lifting rail between said headrail and said bottom rail, said vertical guide rails each having a longitudinal sliding groove, which receives one end of each of said at least one lifting rail.
